(19) United States
(12) Patent Application Publication
(10) Pub. No.: US 2007/0283610 A1
(43) Pub. Date: Dec. 13, 2007

(54) Clip assembly

(76) Inventor: Danny A. Mounce, Covington, KY (US)

Correspondence Address: DINSMORE & SHOHL, LLP, 1900 CHEMED CENTER, 255 EAST FIFTH STREET, CINCINNATI, OH, 45202, US

(21) Appl. No.: 11/449,901

(22) Filed: Jun. 9, 2006

(51) Int. Cl. G09F 3/20

(52) U.S. Cl. 40/658

(57) ABSTRACT

A clip assembly for storing a clip. Particularly, a clip assembly employing a clip and a base, wherein the base includes an extension portion and an attachment portion. Additionally, the clip can be a hat clip which can be joined with a base so that the clip assembly can be attached to a surface and the hat clip can be stored when not in use.

### TECHNICAL FIELD

The present invention relates generally to a clip assembly for storing clips, particularly hat clips. In one exemplary embodiment, the clip assembly employs a clip and a base having an extension portion which is inserted into the clip.

### BACKGROUND OF THE INVENTION

Novelty clips, such as hat clips, are commonly found at many festive events, such as ballparks, stadiums and raceways. Fans of various sporting events use such clips to support their respective players and teams. These novelty clips have become quite popular and provide an inexpensive and unique way for fans to express themselves. However, once the clips are no longer being used a user needs to find a way to store or place their collectable novelty clips to prevent any damage.

The present inventive clip assembly provides a simple, effective and adaptable solution for fans to store such clips when not in use. The clip assembly allows fans to store their clips in a variety of environments, including at the office, home or while they are still at the game or race. The clip assembly provides an effective platform to combine the clips with a base to effectively store the clip by attaching the base to a surface, such as a cabinet, refrigerator or even a coffee mug.

### SUMMARY OF THE INVENTION

Accordingly, it is an object of the present invention to provide a clip assembly.

In one exemplary embodiment, the invention is directed to a clip assembly having a clip and a base. The clip has an upper portion, a lower portion and a rear portion. The upper portion and the lower portion are connected by the rear portion. The upper portion and the lower portion have corresponding surfaces. The base includes an extension portion and an attachment portion. The extension portion is configured to be operably inserted between the corresponding surfaces of the upper portion and the lower portion of the clip. The attachment portion is adapted to attach the clip assembly to a surface.

In another exemplary embodiment, the invention is directed to a clip assembly having a clip and a base. The clip includes an upper portion, a lower portion and a rear portion. The upper portion and the lower portion are connected by the rear portion. The upper portion and the lower portion have corresponding surfaces. The clip is configured to attach to a hat. The upper portion includes a display member operably attached to the clip. The base includes an extension portion and an attachment portion. The extension portion is configured to be operably inserted between the corresponding surfaces of the upper portion and the lower portion of the clip. The attachment portion is adapted to attach the clip assembly to a surface.

The present clip assembly provides a convenient mechanism by which to store a clip, particularly a hat clip, when the clip is not in use. The clip assembly includes having a clip attached to a base which attaches to a surface (i.e., a wall, refrigerator, cabinet, container, glassware, etc.), thus providing a means to store the clip. These and additional advantages of the present invention will be more readily apparent in view of the following detailed description.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 depicts a front plan view of an exemplary embodiment of a clip attached to a hat, the clip including a bobble head device;

FIG. 2 illustrates a side plan view of an exemplary embodiment of a clip displaying an indicia;

FIG. 3A depicts a side plan view of an exemplary embodiment of a clip assembly in a disconnected state;

FIG. 3B illustrates a side plan view of an exemplary embodiment of a clip assembly in a connected state;

FIG. 4A depicts a side plan view of an exemplary embodiment of a clip assembly showing a clip and a base in a disconnected state;

FIG. 4B illustrates a side plan view of an exemplary embodiment of a clip assembly showing a clip and a base in a connected state;

FIG. 5 depicts a side plan view of an exemplary embodiment of a clip assembly in a disconnected state; and

FIG. 6 illustrates a side plan view of an exemplary embodiment of an clip assembly attached to glassware;

FIG. 7 depicts a front plan view of an exemplary embodiment of a clip configured to attach to a packaging base; and

FIG. 8 illustrates a front plan view of an exemplary embodiment of a clip configured to attach to a packaging base.

### DETAILED DESCRIPTION

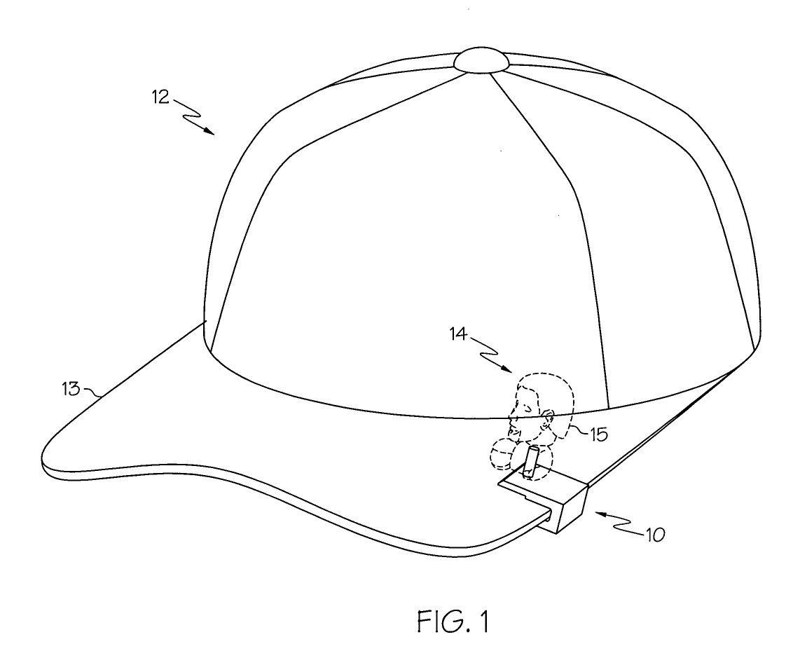

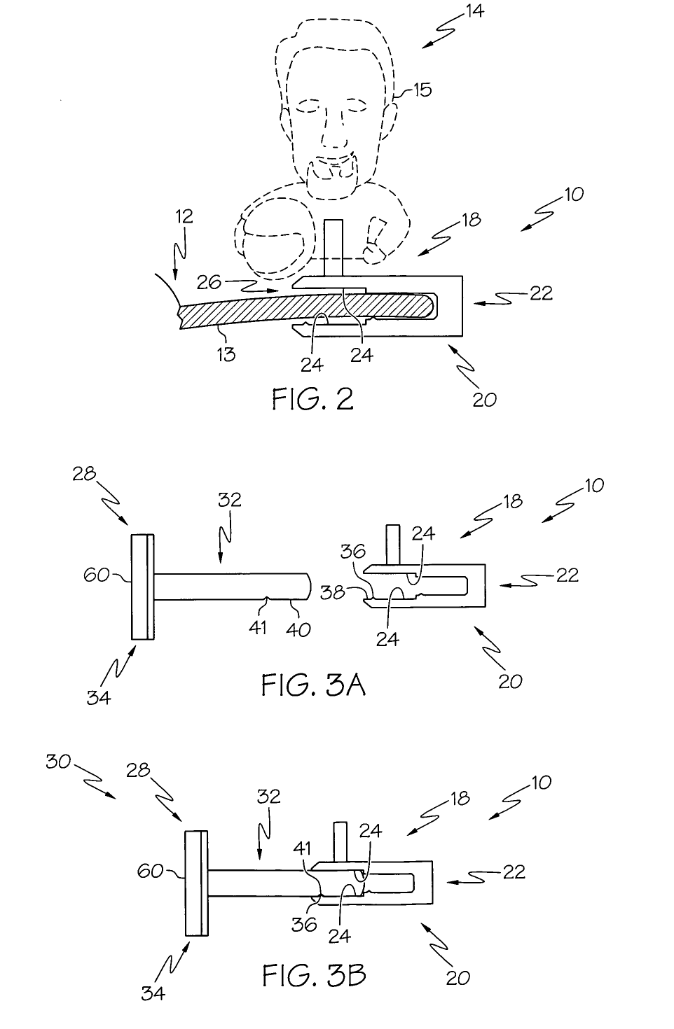

Exemplary embodiments of the present invention and its operation are hereinafter described in detail in connection with the views and examples of FIGS. 1-6, wherein like numbers indicate the same or corresponding elements throughout the views. As shown in the exemplary embodiment of FIG. 1, a clip 10 for a hat 12 can be attached to the bill 13 of a hat 12. The clip 10 can include a display member 14 (i.e., a bobble head device 15). As more clearly shown in the exemplary embodiment of FIG. 2, the bill 13 of the hat 12 is inserted into the clip 10, thus attaching the clip 10 to the hat 12. The clip 10 has an upper portion 18, a lower portion 20 and a rear portion 22. The upper portion 18 and the lower portion 20 are connected by the rear portion 22. The upper portion 18 and the lower portion 20 have corresponding surfaces 24. These corresponding surfaces 24 face one another such that when the clip 10 is engaged, these corresponding surfaces 24 contact an article inserted into a recess 26 of the clip 10 (for example, as illustrated in FIG. 2, where the corresponding surfaces 24 are engaged with the bill 13 of the hat 12). The recess 26 separates the corresponding surfaces 24 of the clip 10. Also as illustrated in the exemplary embodiment of FIG. 2, the display member 14 can be an indicia (not shown). While FIGS. 1 and 2 only illustrate a couple of exemplary embodiments for the display member 14, it can be understood by those skilled in the art that a number of different designs or illustrations can serve as display members 14 which can be associated with the upper portion 18 of the clip 10 such that any number of items can be displayed in association with the clip 10. It is also important to note that in one exemplary embodiment the display member 14 can be integral with the upper portion 18 of the clip 10, but in another exemplary embodiment the clip 10 can be configured to operably receive the display member 14, thus allowing for different types of display members 14 to be applied to the clip 10.

FIGS. 3A and 3B illustrate the clip 10 in association with a base 28 to form a clip assembly 30. The base 28 includes an extension portion 32 and an attachment portion 34. The extension portion 32 is configured to be operatively inserted between the corresponding surfaces 24 of the upper portion 18 and the lower portion 20 of the clip 10. The attachment portion 34 is adapted to attach the clip assembly 30 to a surface (not shown). The exemplary embodiment of FIG. 3A illustrates a clip assembly 30 wherein the base 28 and the clip 10 are separated in a disconnected state. FIG. 3B illustrates an exemplary embodiment of the clip assembly 30 wherein the base 28 is inserted into the clip 10 and are joined in a connected state.

The extension portion 32 of the base 28 as shown in the exemplary embodiments of FIGS. 3A and 3B is configured to enter into the recess 26 of the clip 10 and to be operably held to the clip 10 due to the force exerted on the extension portion 32 from the upper portion 18 and the lower portion 20 of the clip 10. The corresponding surfaces 24 place this exerted force onto the extension portion 32 of the base 28 when the extension portion 32 is received by the clip 10. The frictional force provided between the corresponding surfaces 24 and the extension portion 32 is sufficient to maintain the extension portion 32 between the corresponding surfaces 24. By maintaining the extension portion 32 between the corresponding surfaces 24 as shown in FIG. 3B, the clip assembly 30 can be used to store the clip 10 when the base 28 is attached to the surface. Thus, the base 28 does not become dislodged or disengaged from the clip 10 when it is attached to the surface.

As further illustrated in FIG. 3B, the clip 10 and the base 28 may be lockably engaged. As shown in the exemplary embodiment of FIG. 3B, the clip 10 has at least one knob 36 on one of the corresponding surfaces 24 of the clip 10. This knob 36 extends upward from an upper part 38 of the at least one corresponding surface 24. The extension portion 32 has an outer surface 40 which has a corresponding recessed region 41 (as shown in FIG. 3B) which is configured to align with and receive the knob 36 on the corresponding surface 24 of the clip 10 when the extension portion 32 is inserted into the clip 10. This arrangement provides additional engagement to maintain the extension portion 32 of the base 28 between the corresponding surfaces 24 of the clip 10.

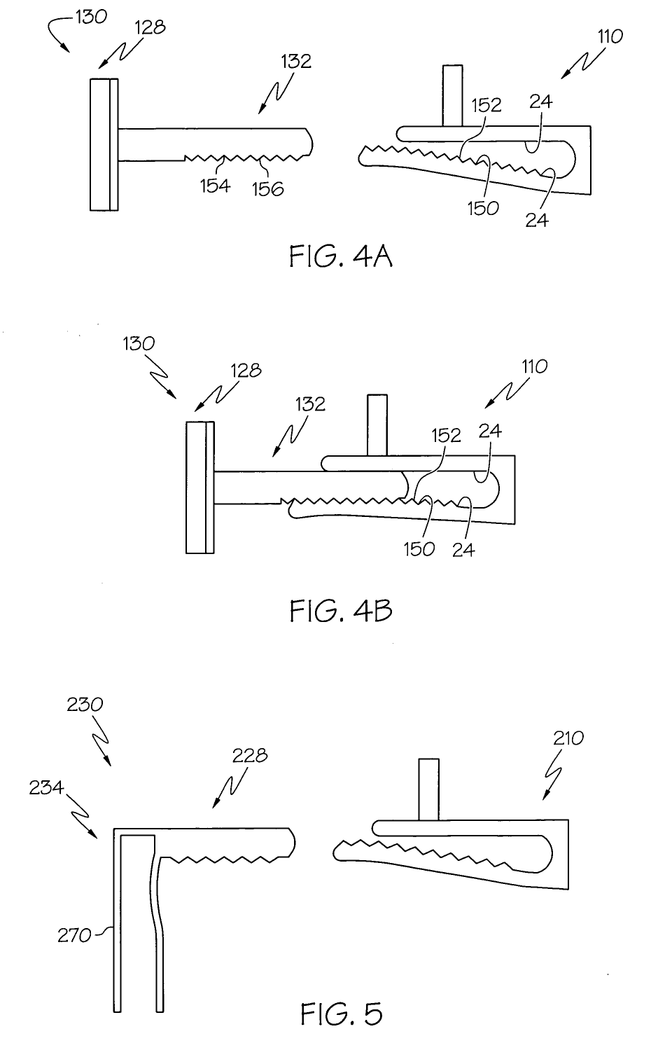

Another exemplary embodiment of a lockable arrangement for a clip assembly 130 is illustrated in FIGS. 4A and 4B. In these exemplary embodiments, at least one of corresponding surfaces 124 includes a gripping surface 150. The gripping surface 150 includes at least one ridge 152, but as shown in the exemplary embodiment of FIG. 4A, the gripping surface 150 may have numerous ridges 152. The gripping surface 150 provides a means in which to provide additional friction and interaction between an extension portion 132 of a base 128 and a clip 110 such that the extension portion 132 does not become disengaged once inserted into the clip 110. FIGS. 4A and 4B also illustrate that the extension portion 132 of the base 128 can include a gripping outer surface 154 having ridges 156 which correspond with those ridges 152 on the gripping surface 150. Once the extension portion 132 is inserted into the clip 110, the gripping outer surface 154 of the extension portion 132 interacts with the gripping surface 150 on the at least one corresponding surface 124 to effectively provide a lockable engagement between the clip 110 and the extension portion 132 as more clearly shown in the exemplary embodiment of the FIG. 4B. As illustrated in FIG. 4B, the ridges 152 on the gripping surface 150 of the clip 110 interlock with the corresponding ridges 156 on the extension portion 132 of the base 128. This interlocking arrangement provides additional engagement to maintain the extension portion 132 between the corresponding surfaces 124 of the clip 110 once the extension portion 132 has been inserted into the clip 110.

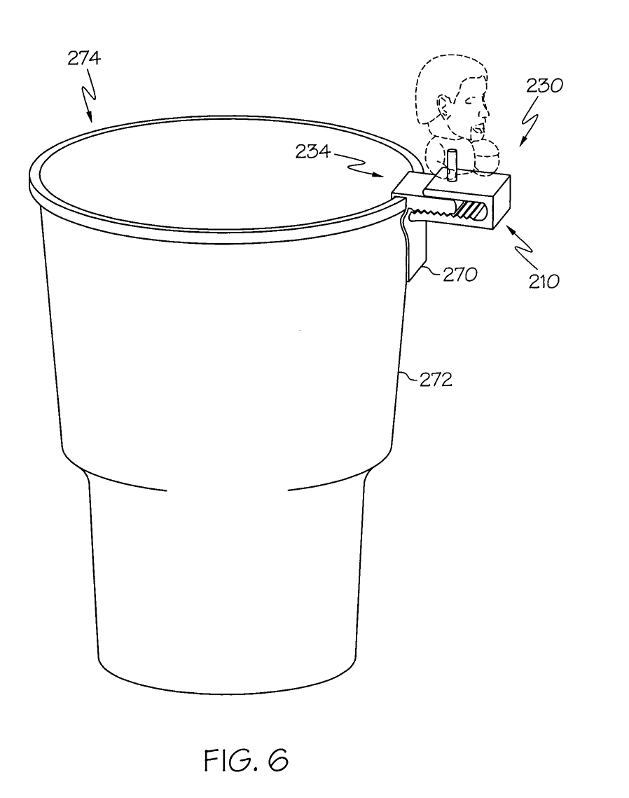

As further illustrated in the exemplary embodiments of FIGS. 3A and 3B, the base 28 also includes the attachment portion 34. The attachment portion 34 provides the mechanism by which to attach the clip assembly 30 to a surface (not shown). As illustrated in FIGS. 3A and 3B, the attachment portion 34 of the base 28 can include a magnet 60. In this embodiment, once the extension portion 32 is inserted into the clip 10 (as shown in FIG. 3B) the clip assembly 30 can be attached to a metal surface (i.e., cabinet, refrigerator) due to the properties of the magnet 60. It is important to note that numerous different exemplary embodiments can be employed to provide a means of attaching the base to a surface. For example, in another exemplary embodiment (not shown), the attachment portion can include a mating portion of a hook and loop arrangement where the mating portion includes at least one of a hook or a loop. For example, the attachment portion can include either the hook or the loop mating portion of a Velcro® design and the surface on which the attachment portion is adapted to attach to has the corresponding hook or loop mating portion. Another exemplary embodiment illustrating an attachment portion 234 is depicted in FIG. 5, which shows a U-shaped clip 270 configured for receiving a mounting surface (not shown). As shown in the exemplary embodiment of FIG. 5, the attachment portion 234 includes a U-shaped clip 270 adapted to be attached to a mounting surface, such as a container wall. In one exemplary embodiment as more clearly depicted in FIG. 6, a container wall 272 can include glassware (i.e., a glass 274), but it is important to note that any type of glassware, i.e., such as mugs, beer bottles, etc., could be utilized in combination with the U-shaped clip 270. The U-shaped clip 270 used as the attachment portion 234 can be configured so that a variety of different shaped mounting surfaces having various thicknesses and geometries can be attached to by the U-shaped clip 270. In addition, other objects having mounting surfaces could also be employed by which to attach a clip assembly 230 having a clip 210 and a base 228 as shown in FIGS. 5 and 6.

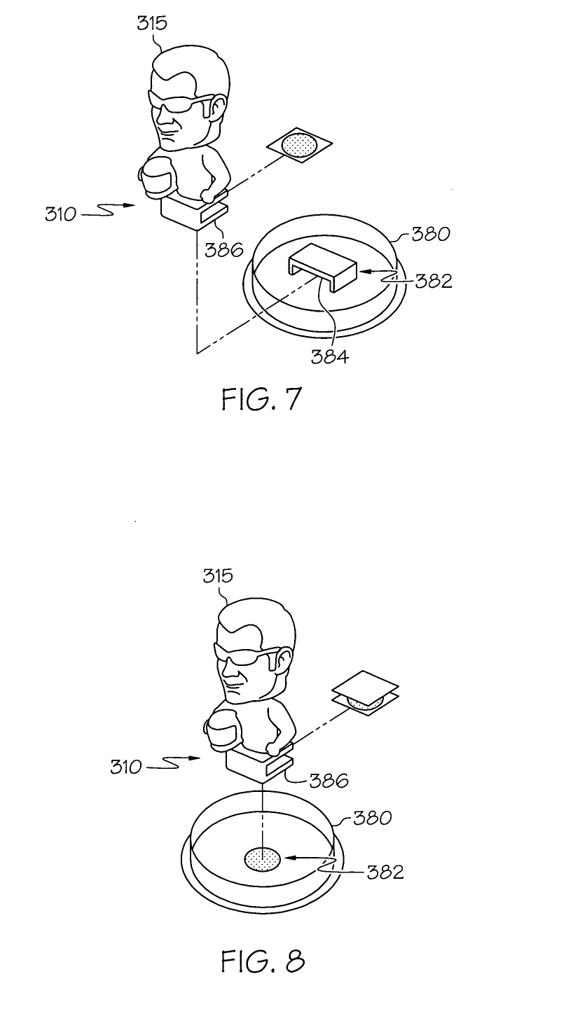

In one exemplary embodiment as illustrated in FIG. 7, the clip 310 having a bobble head device 315 can be configured to attach to a packaging base 380. The packaging base 380 can include a receiving member 382. In one exemplary embodiment as shown in the FIG. 7, the receiving member 382 can include an arch 384 to connect with the clip 310. In another exemplary embodiment, as illustrated in FIG. 8, the receiving member 382 can include a mating portion of a hook and loop arrangement where the mating portion includes at least one of a hook or a loop. For example, the receiving member 382 can include either the hook or the loop mating portion of a Velcro® design and the clip 310 can be configured to have the corresponding hook or loop mating portion integrated with a bottom portion 386 of the clip 310. Also as further illustrated in FIG. 7, the receiving member 382 could include both the arch 384 and the Velcro® design in order to provide a sufficient attachment between the clip 310 and the packaging base 380 to effectively hold the clip 310 in place, particularly to maintain the clip 310 and the bobble head device 315 in a vertical position relative to its packaging even when the clip 310 is disturbed during shipping and handling.

The clip assembly, both the clip and the base, can be made of a flexible plastic material which provides sufficient durability and flexibility to allow a base to be inserted into a clip. However, it is important to note that other materials could be employed which provide both the proper construction and easiness of use for the clip assembly as described above.

While the invention has been so described in detail with reference to specific embodiments thereof, it will be apparent to those skilled in the art that various changes and modifications may be made therein without departing from the spirit of the invention, the scope of which is defined by the following claims.

What is claimed is:

1. A clip assembly comprising:
a clip having an upper portion, a lower portion and a rear portion, wherein the upper portion and the lower portion are connected by the rear portion and the upper portion and the lower portion have corresponding surfaces; and
a base comprising an extension portion and an attachment portion, wherein the extension portion is configured to be operably inserted between the corresponding surfaces of the upper portion and the lower portion of the clip, and wherein the attachment portion is adapted to attach the clip assembly to a surface.

2. The clip assembly as recited in claim 1, wherein the upper portion further comprises a display member.

3. The clip assembly as recited in claim 2, wherein the display member comprises an indicia.

4. The clip assembly as recited in claim 2, wherein the display member comprises a bobble head device.

5. The clip assembly as recited in claim 1, wherein the attachment portion includes a magnet.

6. The clip assembly as recited in claim 1, wherein the attachment portion includes a mating portion of a hook and loop arrangement, wherein the mating portion comprises at least one of a hook or a loop.

7. The clip assembly as recited in claim 1, wherein the attachment portion includes a U-shaped clip configured for receiving a mounting surface.

8. The clip assembly as recited in claim 7, wherein the mounting surface includes a container wall.

9. The clip assembly as recited in claim 1, wherein the upper portion and the lower portion are configured to exert sufficient pressure to maintain the extension portion between the corresponding surfaces.

10. The clip assembly as recited in claim 1, wherein at least one of the corresponding surfaces includes a gripping surface.

11. The clip assembly as recited in claim 10, wherein the gripping surface comprises at least one ridge.

12. The clip assembly as recited in claim 1, wherein the first end of the extension member comprises a gripping outer surface.

13. The clip assembly as recited in claim 10, wherein the extension member comprises a gripping outer surface which interacts with the gripping surface of the at least one of the corresponding surfaces.

14. The clip assembly as recited in claim 1, wherein the clip and the extension member are configured to lockably engage.

15. The clip assembly as recited in claim 1, wherein the clip is configured to receive a bill of a hat.

16. The clip assembly as recited in claim 1, wherein the clip is configured to attach to a packaging base.

17. The clip assembly as recited in claim 1, wherein the clip further comprises a bottom portion which includes a mating portion of a hook and loop arrangement, wherein the mating portion comprises at least one of a hook or a loop.

18. The clip assembly as recited in claim 17, wherein the bottom portion of the clip attaches to a packaging base.

19. A clip assembly comprising:
a clip having an upper portion, a lower portion and a rear portion, wherein the upper portion and the lower portion are connected by the rear portion and the upper portion and the lower portion have corresponding surfaces, wherein the clip is configured to attach to a hat, and wherein the upper portion comprises a display member operably attached to the clip; and
a base comprising an extension portion and an attachment portion, wherein the extension portion is configured to be operably inserted between the corresponding surfaces of the upper portion and the lower portion of the clip, and wherein the attachment portion is adapted to attach the clip assembly to a surface.
